(19) United States
(12) Patent Application Publication
(10) Pub. No.: US 2009/0068439 A1
(43) Pub. Date: Mar. 12, 2009

(54) Construction laminate

(76) Inventors: Timothy C. Callahan, Chippewa Falls, WI (US); John A. Ulcej, Colfax, WI (US)

Correspondence Address: MCCRACKEN & FRANK LLP, 311 S. WACKER DRIVE, SUITE 2500, CHICAGO, IL, 60606, US

(21) Appl. No.: 12/283,365

(22) Filed: Sep. 11, 2008

Related U.S. Application Data
(60) Provisional application No. 60/993,278, filed on Sep. 11, 2007.
(60) Provisional application No. 61/009,223, filed on Dec. 27, 2007.

(51) Int. Cl. B32B 3/26

(52) U.S. Cl. 428/319.7

(57) ABSTRACT

A construction laminate includes a polymeric outer layer and a plurality of alternating polymeric film and foam layers, wherein a first film layer is disposed adjacent the outer layer. The laminate further includes a polymeric inner layer disposed adjacent an innermost of the foam layers.

### CROSS REFERENCE TO RELATED APPLICATIONS

The present application claims the benefit of provisional U.S. Patent Application Nos. 60/993,278, filed Sep. 11, 2007; and 61/009,223, filed Dec. 27, 2007. All of the above listed applications are hereby incorporated by reference herein in their entireties.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to multi-layered rigid structures, and more particularly to multi-layered rigid construction laminates.

2. Description of the Background

In the construction of homes, buildings, and other structures, an exterior structure is installed or constructed adjacent outer walls of a housing structure to protect and/or insulate the housing structure. Brick is oftentimes used as an exterior structure, but brick can be very expensive and construction of brick walls can be very time consuming. Various different types of siding, such as wood, aluminum, steel, or polyvinyl chloride (commonly referred to as “vinyl” or “PVC”) siding have also been utilized. Wood is not always a preferred siding material because wood is difficult to maintain and needs to be replaced more often than other types of siding. Metal and vinyl siding tend to have low thermal insulation properties, and therefore necessitate another layer of an insulating material to attain the insulation properties necessary for the building or housing structure for which the siding is used.

One vinyl siding with an insulating material includes multiple vinyl panels that are separately formed and thereafter connected to one another. A first end of each panel includes a U-shaped member forming a first channel therein, a middle of each panel includes a groove formed therein, and a second end of each panel includes a wall member forming a second channel therein. The U-shaped member of a first panel mates with the wall member of an adjacent panel such that a rib extending from the wall member retains the panels together. An insulation layer having an inner core layer and outer layers of foil on both sides thereof is disposed in each first channel and extends to and is supported by the wall member to provide insulation properties to the vinyl siding.

In other embodiments of vinyl siding, a vinyl outer skin is formed in a conventional manner by extruding same as a flat sheet from a sheet-type die and then post forming the sheet to form the siding. A core of rigid foam is applied to the vinyl outer skin by injecting it into a continuously moving mold containing the vinyl outer skin. The core of rigid foam expands in the mold against the vinyl outer skin to join with the vinyl outer skin and take the shape of the mold.

In yet other embodiments of vinyl siding having insulation, siding units are formed having a reinforcing panel disposed adjacent at least one facing panel. The reinforcing panel is comprised of any sufficiently rigid insulating material, for example expanded polystyrene foam. The facing panel, which forms the siding, is comprised of any thermoplastic material, but more specifically PVC. To create a solid siding unit, the reinforcing panel is glued or otherwise laminated to an inside surface of the at least one facing panel.

Other vinyl sidings include an exterior vinyl layer and first and second internal foam layers. The foam layers may be separated by a reinforced layer. The reinforced layers include either a polymeric material having a filler disposed therein or a reinforcement scrim. Each of the foam layers has a thickness of between 45 and 85 mils, each of the reinforcing layers has a thickness of between 5 and 100 mils, and the exterior layer has a thickness of between 20 and 100 mils.

In the prior art vinyl siding material, one or more thicker foam layers lessen the strength of the siding material, thereby necessitating reinforcing layers, such as scrims, metal frames, etc., which can be expensive. Thicker foam layers also increase the overall thickness of the siding material, and thus also increase the overall cost for the siding material.

### SUMMARY OF THE INVENTION

According to one aspect of the present invention, a construction laminate includes a polymeric outer layer and a plurality of alternating polymeric film and foam layers, wherein a first film layer is disposed adjacent the outer layer. The laminate further includes a polymeric inner layer disposed adjacent an innermost of the foam layers.

According to another aspect of the present invention, a construction laminate includes a polymeric outer layer and a plurality of alternating polymeric and polyvinyl chloride foam layers. A first film layer is disposed adjacent the outer layer, each of the film layers has a substantially similar thickness, and each of the foam layers has a substantially similar thickness. The laminate further includes a polymeric inner layer disposed adjacent an innermost of the foam layers.

According to yet a further aspect of the present invention, a construction laminate includes an outer layer selected from the group consisting of polyvinyl chloride (“PVC”), acrylonitrile styrene acrylate (“ASA”), and acrylonitrile butadiene styrene (“ABS”), wherein the outer layer is ultraviolet light stable. The laminate further includes a plurality of alternating polymeric film and polymeric foam layers, wherein a first film layer is disposed adjacent the outer layer, each of the film layers has a substantially similar thickness, and each of the foam layers has a substantially similar thickness. A polymeric inner layer is disposed adjacent an innermost of the foam layers.

Other aspects and advantages of the present invention will become apparent upon consideration of the following detailed description, wherein like structures have like reference numerals.

### BRIEF DESCRIPTION OF THE DRAWINGS

FIG. 1 is a top isometric view of a first embodiment of a construction laminate;

FIG. 2 is a cross-sectional view taken generally along the lines 2-2 of FIG. 1;

FIG. 3 is a top isometric view of a second embodiment of a construction laminate;

FIG. 4 is a cross-sectional view taken generally along the lines 4-4 of FIG. 3;

FIG. 5 is a top isometric view of a third embodiment of a construction laminate;

FIG. 6 is a cross-sectional view taken generally along the lines 6-6 of FIG. 5;

FIG. 7 is an enlarged cross-sectional view of a film and foam layers of a construction laminate; and

FIG. 8 is an enlarged cross-sectional view of film and foam layers of a construction laminate similar to the construction laminate of FIG. 1.

### DETAILED DESCRIPTION

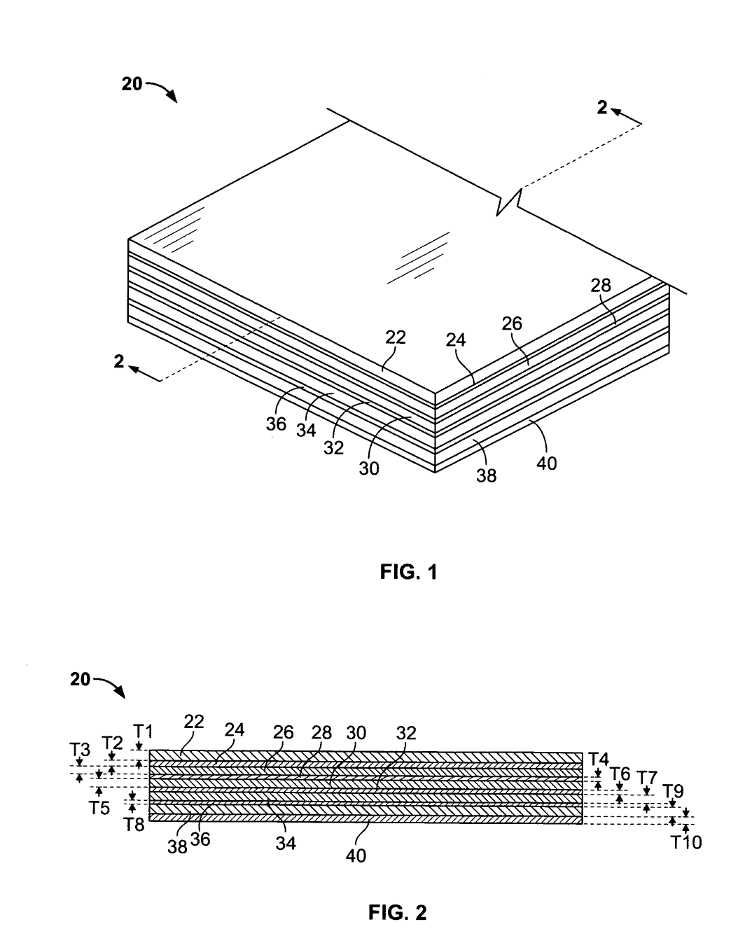

As shown in FIGS. 1 and 2, a first embodiment of a construction laminate 20 includes a top or outer layer 22. The top or outer layer 22 may be made of any polymeric material or mixture of polymeric materials that is ultraviolet light (“UV”) stable, including but not limited to polyvinyl chloride (“PVC”), acrylonitrile styrene acrylate (“ASA”), and acrylonitrile butadiene styrene (“ABS”). The outer layer 22 has a thickness T1 (FIG. 2). A first film layer 24 is disposed adjacent and attached to the outer layer 22. The first film layer 24 may be made of any polymeric material or mixture of polymeric materials, including but not limited to PVC and ABS. The first film layer 24 has a thickness T2. A first foam layer 26 is disposed adjacent and attached to the first film layer 24 and is made of any extrudable foam material or mixture of materials, such as a PVC foam, a polystyrene foam, a polymethacrylimide foam, a polyurethane foam, a polyethylene foam, a polypropylene foam or any other suitable polymeric foam material. The first foam layer 26 has a thickness T3.

Still referring to FIGS. 1 and 2, a second film layer 28 is disposed adjacent and attached to the first foam layer 26, wherein the second film layer 28 may be made of any polymeric material or mixture of polymeric materials, including but not limited to PVC and ABS. The second film layer 28 may be made of the same material as the first film layer 24 or may alternatively be made of a different material. The second film layer 28 has a thickness T4 that may be the same as or similar to the thickness T2 of the first film layer 24, or may alternatively be different.

A second foam layer 30 is disposed adjacent and attached to the second film layer 28. The second foam layer 30 is made of any extrudable foam material or mixture of materials, such as a PVC foam, a polystyrene foam, a polymethacrylimide foam, a polyurethane foam, a polyethylene foam, a polypropylene foam or any other suitable polymeric foam material. The second foam layer 30 may be made of the same material as the first foam layer 26 or optionally may be made of a different material. The second foam layer 30 has a thickness T5 that may be the same as or similar to the thickness T3 of the first foam layer 26, or may alternatively be different.

The construction laminate of FIGS. 1 and 2 further includes a third film layer 32 disposed adjacent and attached to the second foam layer 30, a third foam layer 34 disposed adjacent and attached to the third film layer 32, a fourth film layer 36 disposed adjacent and attached to the third foam layer 34, and a fourth foam layer 38 disposed adjacent and attached to the fourth film layer 36. The third and fourth film layers 32, 36 may be made of any polymeric material or mixture of polymeric materials, including but not limited to PVC and ABS. The third and fourth film layers 32, 36 may be made of the same or different materials and may also be made of the same or different materials than the first and second film layers 24, 28. Thicknesses T6 and T8 of the third and fourth film layers 32, 36 may be the same or different and may also be the same or different than the thicknesses T2 and T4 of the first and second film layers 24, 28.

The third and fourth foam layers 34, 38 may be made of any extrudable foam material or mixture of materials, such as a PVC foam, a polystyrene foam, a polymethacrylimide foam, a polyurethane foam, a polyethylene foam, a polypropylene foam or any other suitable polymeric foam material. The third and fourth foam layers 34, 38 may be made of the same or different materials and may also be made of the same or different materials than the first and second foam layers 26, 30. Thicknesses T7 and T9 of the third and fourth foam layers 34, 38 may be the same or different and may also be the same or different than the thicknesses T3 and T5 of the first and second foam layers 26, 30.

Still referring to FIGS. 1 and 2, a bottom or inner layer 40 is disposed adjacent and attached to the fourth foam layer 38. The bottom layer 40 may be made of any polymeric material or mixture of materials, including but not limited to, PVC or ABS. The bottom layer 40 has a thickness T10.

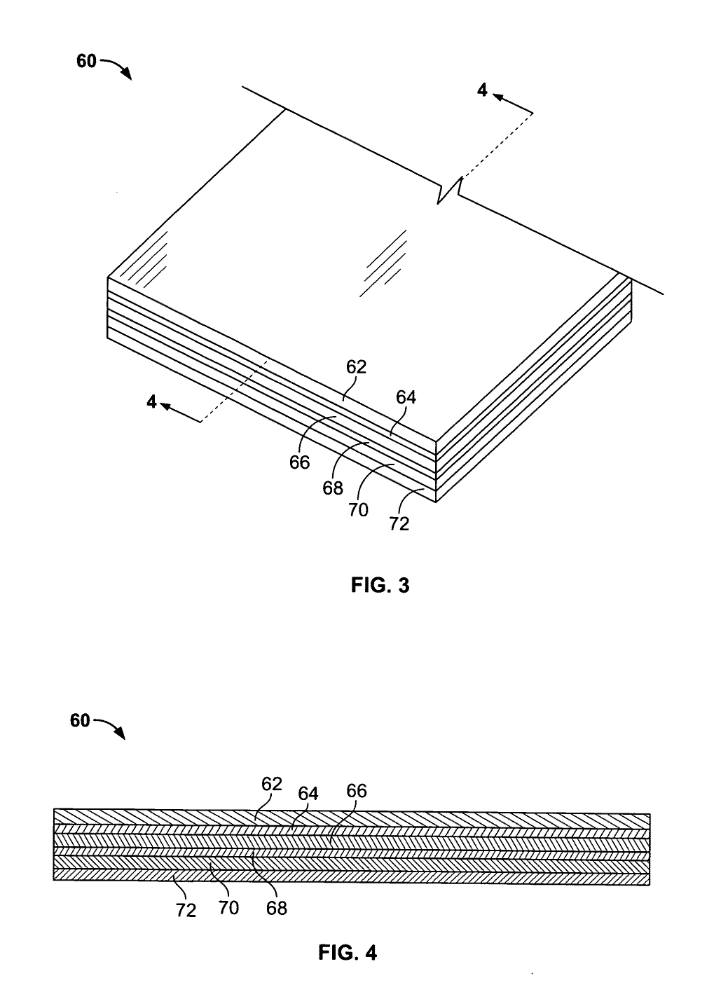

A second embodiment of a construction laminate 60 is shown in FIGS. 3 and 4. The construction laminate includes a cap or outer layer 62 made of any polymeric material or mixture of polymeric materials that is ultraviolet light (“UV”) stable, including but not limited to polyvinyl chloride (“PVC”), acrylonitrile styrene acrylate (“ASA”), and acrylonitrile butadiene styrene (“ABS”). A first film layer 64 is disposed adjacent and attached to the outer layer 62, a first foam layer 66 is disposed adjacent and attached to the first film layer 64, a second film layer 68 is disposed adjacent and attached to the first foam layer 66, and a second foam layer 70 is disposed adjacent and attached to the second film layer 68. Each of the film layers 64, 68 may be made of any polymeric material or mixture of polymeric materials, including but not limited to PVC and ABS and each of the foam layers 66, 70 may be made of any extrudable foam material or mixture of materials, such as a PVC foam, a polystyrene foam, a polymethacrylimide foam, a polyurethane foam, a polyethylene foam, a polypropylene foam or any other suitable polymeric foam material. The film layers 64, 68 may be made of the same or different materials and the foam layers 66, 70 may be made of the same or different materials. A bottom or inner layer 72 is disposed adjacent and attached to the second foam layer 70, wherein the bottom layer 72 may be made of any polymeric material, including but not limited to, PVC or ABS.

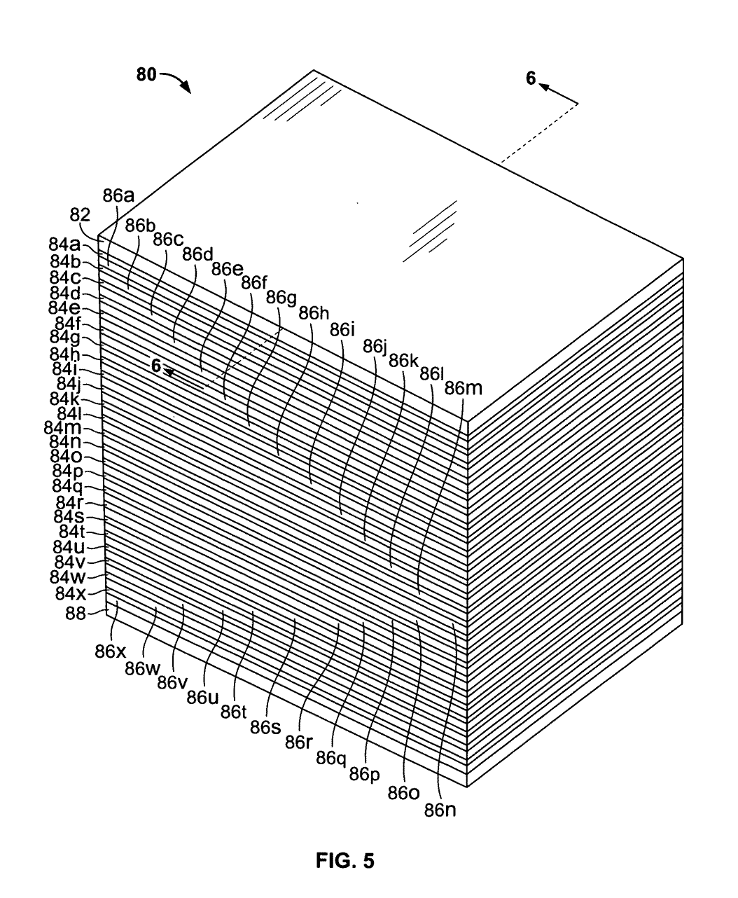

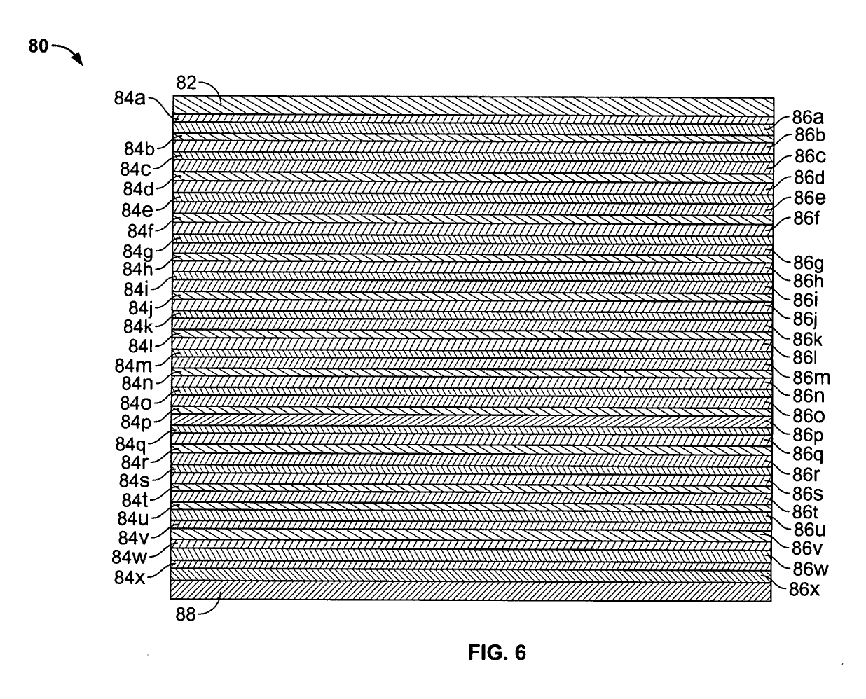

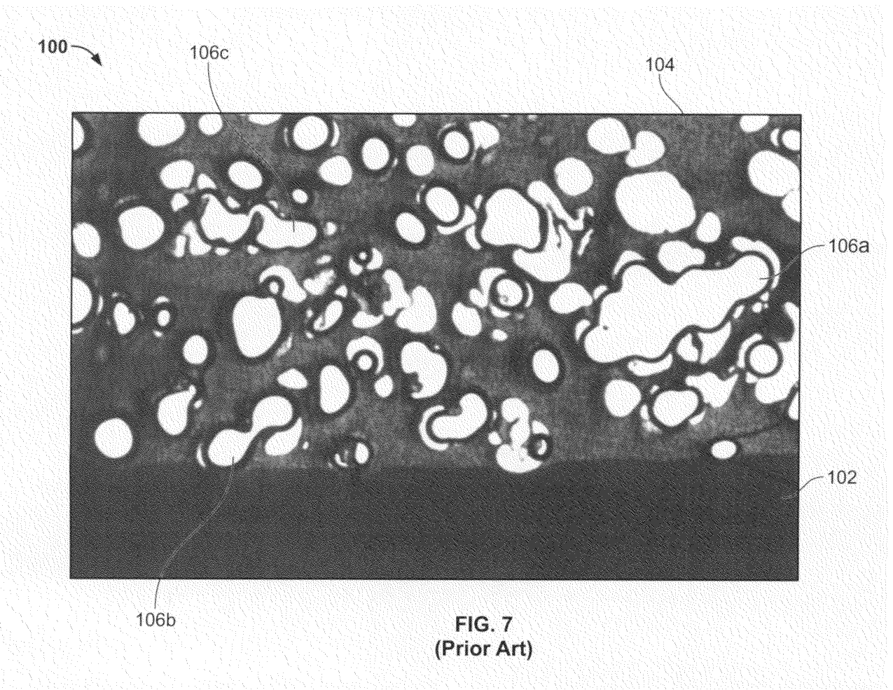

FIGS. 5 and 6 depict a third embodiment of a construction laminate 80. The construction laminate 80 includes a cap or outer layer 82 made of any polymeric material or mixture of polymeric materials that is ultraviolet light (“UV”) stable, including but not limited to polyvinyl chloride (“PVC”), acrylonitrile styrene acrylate (“ASA”), and acrylonitrile butadiene styrene (“ABS”). Alternating film layers 84a-84x and foam layers 86a-86x are disposed such that a first film layer 84a is disposed adjacent and attached to the outer layer 82 and adjacent film layers 84a-84x and foam layers 86a-86x are disposed adjacent and attached to one another. Each of the film layers 84a-84x may be made of any polymeric material or mixture of polymeric materials, including but not limited to PVC and ABS and each of the foam layers 86a-86x may be made of any extrudable foam material or mixture of materials, such as a PVC foam, a polystyrene foam, a polymethacrylimide foam, a polyurethane foam, a polyethylene foam, a polypropylene foam or any other suitable polymeric foam material. Any number of the film layers 84a-84x may be made of the same or any number of different materials and/or any number of the foam layers 86a-86x may be made of the same or any number of different materials.

Referring to FIG. 7, film and foam layers of a prior art construction laminate 100 are depicted (omitting outer and inner layers). The construction laminate 100 includes a single film layer 102 and a single foam layer 104 disposed adjacent and attached to the film layer 102. During the extrusion of the film and foam layers 102, 104, one or more blowing and/or nucleating agents are utilized to create voids 106 within the foam layer 104. The blowing and/or nucleating agents displace the foam material to create voids, thereby forming the foam layer 104. Optionally, instead of using blowing and/or nucleating agents, a filler can be used to displace the foam material. Examples of fillers include calcium carbonate, saw dust, or any other fine particles that would displace the foam material in an appropriate manner. A size of the voids 106 is directly related to a strength of the foam layer 104. In particular, the larger the size of the voids 106, the weaker the foam layer 104. Oftentimes, the size of the voids 106 is increased by clumping up of the blowing agents, nucleating agents, and/or fillers as depicted by voids 106a-106c in FIG. 7, thereby weakening the foam layer 104. The size of the voids 106 can be slightly controlled by the amount and size of the blowing agents, nucleating agents, and/or fillers used, but this does not provide unlimited control of the size of the voids 106.

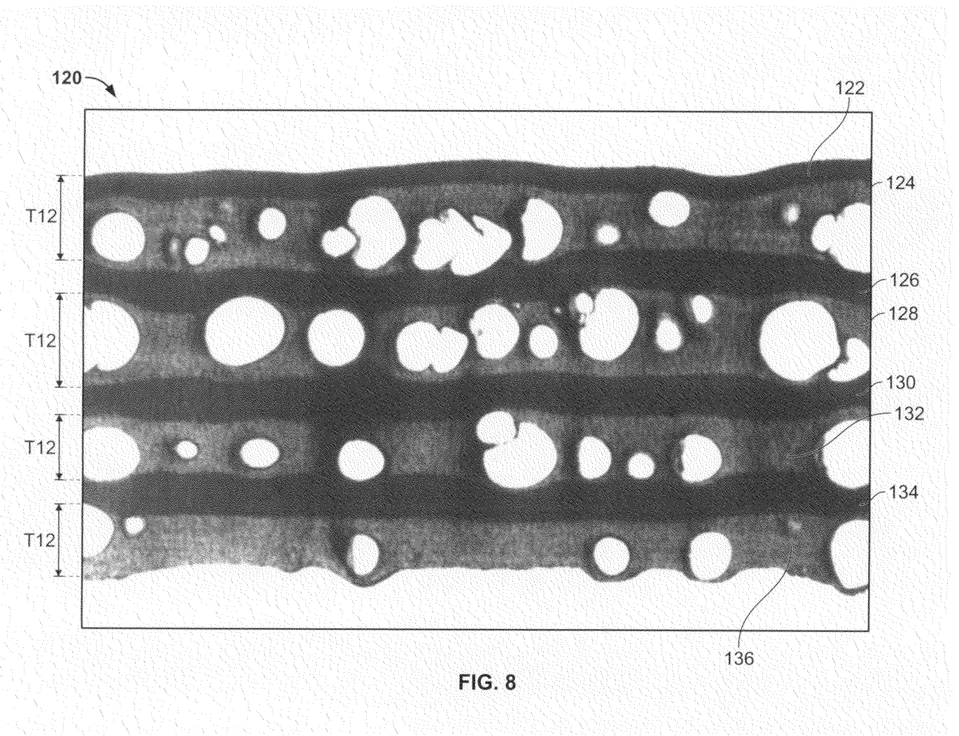

FIG. 8 depicts a construction laminate 120 of the present invention having multiple thinner film and foam layers. In particular, four film layers 122, 126, 130, 134 are alternated with four foam layers 124, 128, 132, 136 in a manner similar to the film and foam layers of the construction laminate 20 of FIG. 1. The voids 140 created in the construction laminate 120 of FIG. 8 have a size in one direction that is limited to a thickness T12 of the foam layer 124, 128, 132, 136. The more layers included within the construction laminate 120, the smaller the thickness T12 can be, thereby limiting a size of voids 140 within the foam layers 124, 128, 132, 136 and strengthening the foam layers 124, 128, 312, 136 and the overall laminate 120. As discussed in detail above, the thickness T12 can be different for each foam layer 124, 128, 132, 136.

Although the embodiments herein show 2, 4, and 24 each of the film and foam layers, any number of alternating foam and film layers between 2 and 24 is possible depending on the structure for which the laminate is utilized.

In addition, the embodiments of construction laminates disclosed herein may be used for constructing any structures, such as siding for buildings and homes, trimming, decking, fencing, and the like. The construction laminates can also be used in vehicles such as buses, automobiles, and the like.

The layers of each of the construction laminates disclosed herein may generally have the same size and shape. Although the construction laminates as disclosed herein are depicted as being rectangular in shape, the laminates may be constructed of any shape that can be manufactured and that would be sufficient for siding. In addition, any size construction laminate may be created and/or multiple construction laminates may be manufactured and thereafter attached or connected by any means know in the art of construction laminates and siding.

American Society for Testing and Materials (“ASTM”) International has created testing methods for determining the energy required to crack or break rigid PVC plastic sheeting and profile flat sections used as building products under specified conditions of impact. The standard test methods are detailed under the active standard ASTM D4226-05, wherein a first procedure is used to determine a minimum impact energy required to cause failure (by hole, crack, split, shatter, or tear) and a second procedure is used to determine a minimum impact energy required to cause brittle failure. An example of a machine that can perform such tests is the Gardner Heavy Duty Impact Tester Mode IG-1120. Using such a machine, a specimen is placed over a hole having a 0.640 inch diameter in a die mounted in an anvil. A round nosed punch having a 0.625 inch diameter is placed upon the specimen. A weight is raised to a desired height in a 40 inch guide tube and dropped. Damage to the specimen may be determined upon visual inspection or through use of low-powered magnification. Weights of 2 and 4 pounds offer impact forces of 80 and 160 inch-lbs, respectively.

The laminates 20, 60, and 80 of the present disclosure have been designed such that, when the procedures of ASTM D4226-05 are utilized, the impact forces necessary for the laminates 20, 60, and 80 to fail are maximized.

One manner in which any of the embodiments herein may be manufactured is by extruding one or more of the layers therein. An apparatus such as those described in Schrenk U.S. Pat. No. 3,884,606, Alfrey, Jr. et al. U.S. Pat. No. 4,094,947, Schrenk et al. U.S. Pat. No. 5,094,793, Schrenk et al. U.S. Pat. No. 5,380,479, and Schrenk et al. U.S. Pat. No. 5,628,950, the disclosures of which are hereby incorporated by reference, may be utilized to extrude the layers to create any of the construction laminates as described herein. Further, any other apparatus known by one skilled in the art may also be utilized.

### INDUSTRIAL APPLICABILITY

The preceding embodiments of construction laminates of the present application are for use in construction of homes, buildings, and other structures. The laminates provide protective structures with insulative properties, without weakening the overall laminates and also provide lower-cost laminates.

Numerous modifications to the present disclosure will be apparent to those skilled in the art in view of the foregoing description. Accordingly, this description is to be construed as illustrative only and is presented for the purpose of enabling those skilled in the art to make and use the embodiments of the present disclosure and to teach the best mode of carrying out same. The exclusive rights to all modifications which come within the scope of the appended claims are reserved.

We claim:

1. A construction laminate, comprising:
a polymeric outer layer;
a plurality of alternating polymeric film and foam layers, wherein a first film layer is disposed adjacent the outer layer; and
a polymeric inner layer disposed adjacent an innermost of the foam layers.

2. The construction laminate of claim 1, wherein the polymeric outer layer is selected from the group consisting of: polyvinyl chloride (“PVC”), acrylonitrile styrene acrylate (“ASA”), and acrylonitrile butadiene stryrene (“ABS”).

3. The construction laminate of claim 2, wherein the polymeric outer layer is ultraviolet light stable.

4. The construction laminate of claim 3, wherein each of the film layers is selected from the group consisting of: PVC and ABS.

5. The construction laminate of claim 4, wherein each of the film layers is made of the same material.

6. The construction laminate of claim 5, wherein each of the foam layers is selected from the group consisting of: a PVC foam, a polystyrene foam, a polymethacrylimide foam, a polyurethane foam, a polyethylene foam, and a polypropylene foam.

7. The construction laminate of claim 6, wherein each of the foam layers is made of the same material.

8. The construction laminate of claim 7, wherein the polymeric inner layer is selected from the group consisting of: PVC and ABS.

9. The construction laminate of claim 1 having four each of the film and foam layers.

10. A construction laminate, comprising:
a polymeric outer layer;
a plurality of alternating polymeric film and polyvinyl chloride foam layers, wherein a first film layer is disposed adjacent the outer layer, each of the film layers has a substantially similar thickness, and each of the foam layers has a substantially similar thickness; and
a polymeric inner layer disposed adjacent an innermost of the foam layers.

11. The construction laminate of claim 10, wherein the polymeric outer layer is selected from the group consisting of: PVC, ASA, and ABS.

12. The construction laminate of claim 11, wherein the polymeric outer layer is ultraviolet light stable.

13. The construction laminate of claim 12, wherein each of the film layers is selected from the group consisting of: PVC and ABS.

14. The construction laminate of claim 13, wherein each of the film layers is made of the same material.

15. A construction laminate, comprising:
an outer layer selected from the group consisting of PVC, ASA, and ABS, wherein the outer layer is ultraviolet light stable;
a plurality of alternating polymeric film and foam layers, wherein a first film layer is disposed adjacent the outer layer, each of the film layers has a substantially similar thickness, and each of the foam layers has a substantially similar thickness; and
a polymeric inner layer disposed adjacent an innermost of the foam layers.

16. The construction laminate of claim 15, wherein each of the film layers is selected from the group consisting of: PVC and ABS.

17. The construction laminate of claim 16, wherein each of the film layers is made of the same material.

18. The construction laminate of claim 17, wherein each of the foam layers is selected from the group consisting of: a PVC foam, a polystyrene foam, a polymethacrylimide foam, a polyurethane foam, a polyethylene foam, and a polypropylene foam.

19. The construction laminate of claim 18, wherein each of the foam layers is made of the same material.

20. The construction laminate of claim 15 having four each of the film and foam layers.
